(19) United States
(12) Patent Application Publication
(10) Pub. No.: US 2015/0346915 A1
(43) Pub. Date: Dec. 3, 2015

(54) Method and system for automating data processing in satellite photogrammetry systems

(71) Applicant: ROLTA INDIA LTD, Mumbai (IN)

(72) Inventors: Ravindra N. Kondekar, Mumbai (IN); Laxmidhar V. Gaopande, Mumbai (IN); Akhil N. Bavisi, Mumbai (IN)

(73) Assignee: ROLTA INDIA LTD, Mumbai (IN)

(21) Appl. No.: 14/291,014

(22) Filed: May 30, 2014

(51) Int. Cl. G06F 3/0482; G06F 3/0484; G06T 5/00; G06T 17/05; G06T 15/10

(52) U.S. Cl. CPC G06F 3/0482; G06T 17/05; G06T 15/10; G06T 5/00; G06F 3/04842; G06T 2207/10032

(57) ABSTRACT

Disclosed herein are a method and a system for automating data processing in satellite photogrammetry systems. The system supports generation of different types of outputs. A user, while creating a project, may specify desired quality level of outputs which will be generated as part of the project. The system based on the desired quality level of output specified by the user, chooses optimum values of parameters required to generate each output with the specified quality level. Further, the system generates all outputs with the specified quality level, using the optimum values of parameters.

### TECHNICAL FIELD

The embodiments herein relate to satellite photogrammetry and, more particularly, to automated data processing in satellite photogrammetry systems.

### BACKGROUND

Photogrammetry is a measurement technology in which three dimensional co-ordinates of points on an object are determined. Its most important feature is the fact that the objects are measured without being touched. This is achieved by employing the principle of triangulation which means that measurements are made in two photographic images taken from different positions and intersecting lines in space are used to compute the location of a point in all three dimensions. The results are co-ordinates of the required object points, 3 D terrain models, topographical maps and contours, and orthophotos. Contour lines are the most common method of showing relief and elevation on a standard topographic map. A contour line represents an imaginary line on the ground, above or below sea level. Orthophotos are aerial photographs which are geometrically corrected and adjusted for topographic relief to give an accurate presentation of earth's surface to measure true distances like a map.

The existing photogrammetry and terrain processes involve user interference at each step. There is a specific module or software to generate each of the specific output i.e. setup and satellite triangulation, DEM, orthophoto, contour, relief, slope, fly-through, etc. Each of these modules or softwares has their set of parameters which need to be defined by the user so as to achieve the objective. This requires prior knowledge, understanding and education of photogrammetry and its workflows on the part of the user. It provides irrelevant and/or unusable output due to improper combination of input parameters. This gives rise to hassles of performing multiple iterations on various combinations of parameters so as to generate quality output. The existing processes are thus parameter intensive and require in-depth understanding of each and every parameter. All these processes involve multiple steps which necessitate shuffling across multiple modules, softwares and their environments. Output from one process become input for the subsequent process. So, the user needs to define path on the disk to store output file along with its name. While defining it as input in subsequent processes, user needs to select the proper file from the specified path from the disk. Thus, data input/output paths are entered by physical file selection from the disc.

### BRIEF DESCRIPTION OF THE FIGURES

The embodiments herein will be better understood from the following detailed description with reference to the drawings, in which:

FIG. 1 illustrates a block diagram of automated data processing framework, as disclosed in the embodiments herein;

FIG. 2 is a block diagram which depicts various components of automated photogrammetry and terrain display system, as disclosed in the embodiments herein; and

FIG. 3 is a flow diagram which depicts steps involved in the process of automating data processing process using the automated data processing framework, as disclosed in the embodiments herein; and

FIGS. 4a, 4b, 4c, 4d, 4e, and 4f depict examples of user interfaces provided for users to access different functionalities of the automated data processing framework, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

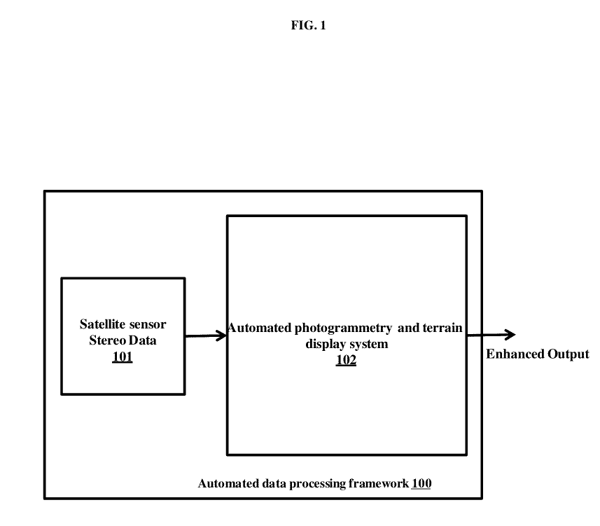

The embodiments herein disclose a system and method for automating data processing process associated with satellite photogrammetry by automatically choosing optimum value of parameters required to enhance the image to match level of detail specified by a user. Referring now to the drawings, and more particularly to FIGS. 1 through 4, where similar reference characters denote corresponding features consistently throughout the figures, there are shown embodiments.

FIG. 1 illustrates a block diagram of automated data processing framework, as disclosed in the embodiments herein. The automated data processing framework 100 comprises of at least one satellite sensor 101, and an automated photogrammetry and terrain display system 102. The automated photogrammetry and terrain display system 102 collects images from the satellite sensor 101.

The automated photogrammetry and terrain display system 102 provides option for the user to select type of image required, and specify a desired quality level. For example, the system may provide option for the user to choose the desired quality level of output as Coarse, Moderate, or Fine; where Coarse may indicate minimum quality level, Moderate may indicate a moderate quality level, and Fine may indicate a maximum quality level. In a preferred embodiment, the quality level selection can be made only at a project level, and not at individual output level, as each output is generated as part of a sequential process. This means if the user selects desired quality level as “Coarse” while creating a project, then this quality level remains same and is applicable to all outputs generated as part of this particular project. The automated photogrammetry and terrain display system 102 provides at least one of Digital Elevation Models (DEM), contour, slope, relief, and flythrough as output. If the user has chosen the desired quality level as “Coarse” while creating the project, then all outputs are generated with the same quality level. The automated photogrammetry and terrain display system 102, upon receiving the input data, type of image, and desired quality level as inputs; automatically chooses optimum value of all parameters required to produce an output that matches the preferences in terms of desired quality, and type of image, the user has set. Further, the generated output may be displayed to the user using a suitable output interface.

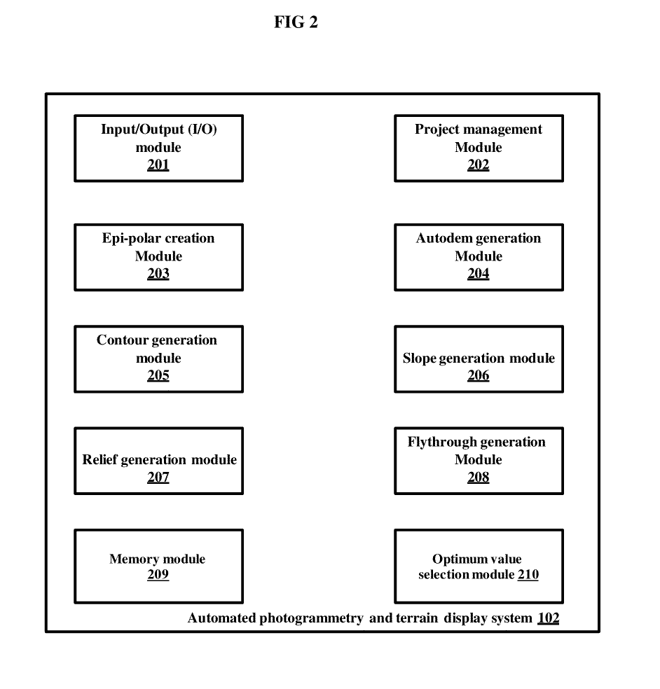

FIG. 2 is a block diagram which depicts various components of automated photogrammetry and terrain display system, as disclosed in the embodiments herein. The automated photogrammetry and terrain display system 102 further comprises of an Input/Output (I/O) module 201, a project management module 202, an Epi-polar creation module 203, an Autodem generation module 204, a Contour generation module 205, a Slope generation module 206, a Relief generation module 207, a Fly-through generation module 208, a memory module 209, and an optimum value selection module 210.

The I/O module 201 may act as an interface between the automated photogrammetry and terrain display system 102, and the satellite sensor 101 to collect images from the satellite. The I/O interface 201 further provides means for the user to interact with the automated photogrammetry and terrain display system 102 to provide inputs, and to specify desired quality level. Further, output image may be displayed to the user, using the I/O interface 201.

The project management module 202 helps the user to create and manage project. The project management module 202 provides options for the user to create a project, define project name and location, define project parameters, and to choose input images.

The Epi-polar creation module 203 helps to automate process of generation of Epi-Polar image pair inputs required for the automated photogrammetry and terrain display system 102. The Epi-polar images are stereo pairs in which the left and right images are oriented in such a way that ground feature points have the same y-coordinates on both images. Using Epi-polar images removes one dimension of variability, thus greatly increasing the speed of image-matching processing as well as the reliability of the matching results.

The Autodem generation module 204 automates the process of generation of Digital Elevation Models (DEM) required to generate orthoimages. The Autodem generation module 204 automatically chooses optimum values of parameters required for generating the DEMs, by selecting optimum values of the parameters to meet a user specified quality level, using the optimum value selection module 210.

The contour generation module 205 provides means for the user to generate, and view contour maps. The user can specify desired quality level while creating the project, according to which the contour generation module 205 chooses optimum value of parameters required to generate the contour maps, using the optimum value generation module 210. The contour generation module 205, using the selected optimum value of parameters, generates the contour output.

The slope generation module 206 is to generate slope map according to user specified quality level. The slope generation module 206, based on desired quality level specified by the user while creating the project, selects optimum values of parameters required to generate the slope, and generates the slope automatically with minimal user intervention.

The relief generation module 207 provides means to generate relief map according to desired quality level specified by the user. When the user selects a relief generation option, the relief generation module 207 prompts the user to select input and output file for the relief generation. Further, the user has to enter relief. Based on the received inputs, and desired quality level the user chose while creating the project, the relief generation module 207 generates the relief map.

The flythrough generation module 208 is to automate the process of generation of flythrough videos. The user can specify desired quality level of output flythrough videos. In a preferred embodiment, the user can choose the desired quality level only when creating the project, which the flythrough generation module 208 selects as desired quality level for the flythrough output. Accordingly, the flythrough generation module 208 selects optimum value of parameters required to generate the flythrough video that matches quality levels specified by the user, and then generates the flythrough using the optimum values selected.

The memory module 209 stores at least one database in which information such as optimum value of parameters required for generating each of the different types of images, with a specified quality level is stored. For example, the database possesses information on optimum values of parameters to generate contour maps in coarse, medium, and fine standards. Similarly, the database possesses similar information corresponding to other supported image/video outputs.

The optimum value selection module 210 may act as an interface between the memory module 209, and the other modules which generates different types of image/video outputs; and helps to select optimum value of parameters required to generate a particular output with a particular quality level. For example, when the user invokes contour generation with “Fine” quality, the optimum value selection module 210 selects optimum value of parameters required to generate contour with Fine quality, and provides these values to the contour generation module 205.

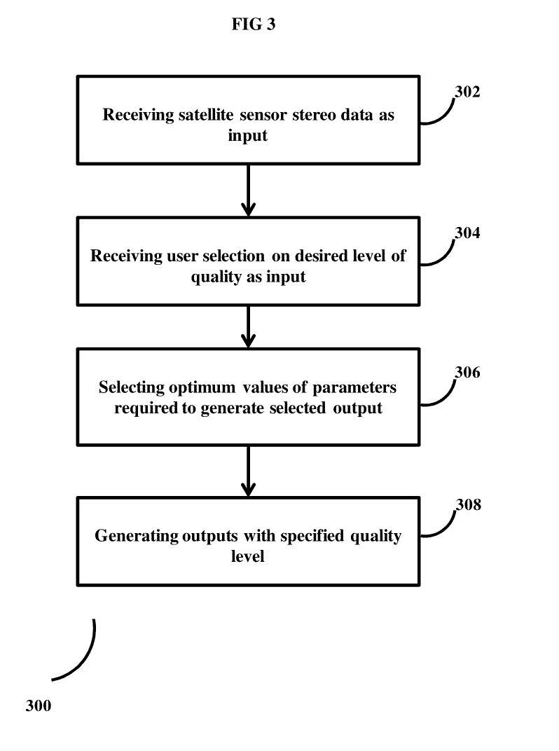

FIG. 3 is a flow diagram which depicts steps involved in the process of automating data processing using the automated data processing framework, as disclosed in the embodiments herein. The automated photogrammetry and terrain display system 102 is connected to at least one satellite sensor 101, from which it receives (302) satellite sensor stereo data as input. The automated photogrammetry and terrain display system 102 provides options for the user to select (304) the desired quality level with which output data is to be generated by the automated photogrammetry and terrain display system 102. The automated photogrammetry and terrain display system 102 provides at least one of Digital Elevation Models (DEM), contour, slope, relief, and flythrough as output, with a desired quality level. The user can generate these outputs with a desired quality level, by specifying the same while creating a project. In an embodiment, the desired quality level may be set only at a project level, and not at individual output level. The user may get at least three different quality standards to choose from; namely “Coarse”, “Moderate”, and “Fine”. Choosing “Coarse” option may provide the user a low quality output, “Moderate” option may provide a moderate quality output, and “Fine” option may provide a high quality output. In another embodiment, if the user didn't choose the desired quality level, the automated photogrammetry and terrain display system 102 may choose a default quality level which is pre-defined and configured by an authorized person.

In a preferred embodiment, the automated photogrammetry and terrain display system 102 automates the process of generating maps according to a user specified desired quality level, by automatically selecting (306) optimum values of parameters required to generate preferred output with desired quality level. The automated photogrammetry and terrain display system 102 maintains information related to different parameters required to generate each type of output supported by the system, in the memory module 209. The memory module 209 further possesses information on optimum value of each of the parameters, required to generate each of the supported outputs, with a desired quality level. The data may be mapped as mentioned below:

Type of output→Parameters required to generate the output→Optimum value of each parameter to generate output that matches (Coarse, Moderate, Fine) quality level

When the user opts to receive outputs with a particular quality level, the user request received at the I/O module 201 is routed to corresponding modules that are capable of generating different types of outputs the automated photogrammetry and terrain display system 102 offers to provide. In an embodiment, when the user creates a new project and specifies a desired quality level, the automated photogrammetry and terrain display system 102 generates all types of outputs, in a sequential manner. Further, the module which received the request (for example, the contour generation module 205 in the above mentioned scenario) communicates with the optimum value selection module 205 to identify optimum values of parameters required to generate output that matches user's requirements. In an embodiment, each module in the automated photogrammetry and terrain display system 102 which generates specific output image/video possesses information about parameters required to generate corresponding output. In this case, the module which has received the user request may communicate with the optimum value selection module 210, the list of parameters for which the optimum values need to be selected. In another embodiment, the module which received the user request may communicate the received request with the optimum value selection module 210, which in turn communicates with the memory module 209 to identify the type of parameters required to generate the user specified output, and corresponding optimum values. In this case, the list of parameters required to generate each type of output is stored in the memory module, along with corresponding optimum value information. In either scenario, the optimum value selection module 210 selects (306) optimum value of parameters required to generate an output with desired quality standards, and sends this information to the module which is responsible for generating the required output. Based on the optimum values selected, the automated photogrammetry and terrain display system 102 generates the output, which in turn can be provided to the user via suitable means associated with the I/O interface 201.

The various actions in method 300 may be performed in the order presented, in a different order or simultaneously. Further, in some embodiments, some actions listed in FIG. 3 may be omitted.

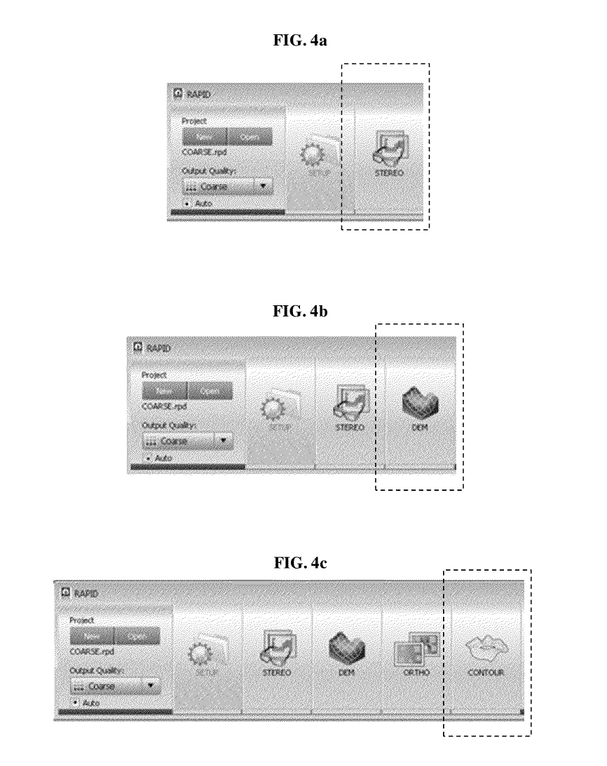

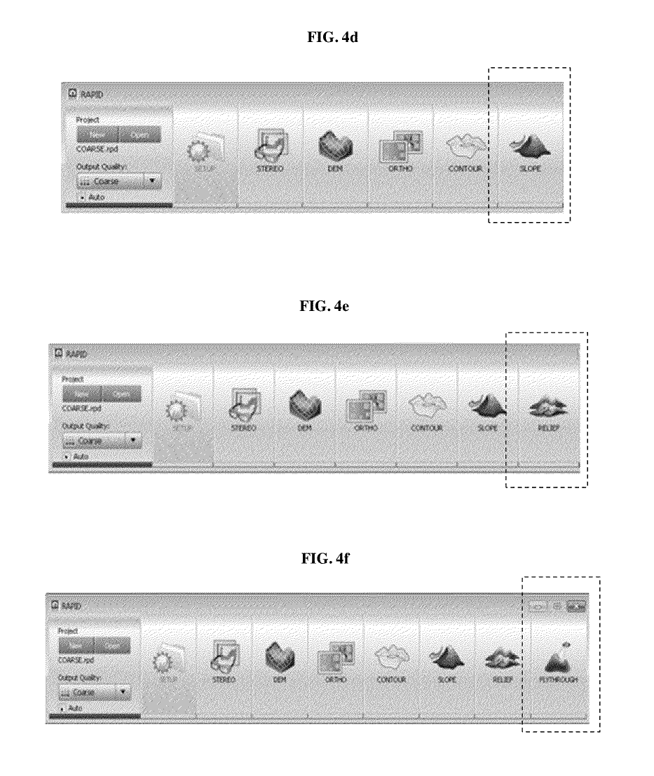

FIGS. 4a, 4b, 4c, 4d, 4e, and 4f depict examples of user interfaces provided for users to access different functionalities of the automated data processing framework, as disclosed in the embodiments herein.

FIG. 4a is an example figure which depicts interface that may be provided to the user to generate the Epi-polar image pair. The user can use the “stereo” option in the interface to generate the Epi-polar images easily. FIG. 4b is an example figure which depicts a user interface that may be provided to the user to generate the DEMs. The user can choose the desired quality level, and click on the “DEM” option to generate the DEMs. FIG. 4c is an example figure that depicts a user interface that may be provided to the user to generate the contour maps. The user can choose desired level of detail, and click on the “Contour” option to generate the contour map. FIG. 4d is an example figure that depicts a user interface that may be provided to the user to generate the slope. The user can choose desired level of detail, and click on the “Slope” option to generate the slope output. FIG. 4e is an example figure that depicts a user interface that may be provided to the user to generate the relief. The user can choose desired level of detail, and click on the “Relief” option to generate the relief output. FIG. 4f is an example figure which depicts a user interface that may be provided to the user to generate the flythrough. The user can choose desired level of detail, and click on the “Flythrough” option to generate the flythrough output.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein specify a system for automated data processing in satellite systems. The mechanism allows automating process of generating satellite images of various types with different quality levels, providing a system thereof. Therefore, it is understood that the scope of protection is extended to such a system and by extension, to a computer readable means having a message therein, said computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device may also include means which could be for ex. hardware means like an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment may be implemented on different hardware devices, for ex. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method of automating data processing in a satellite photogrammetry system, said method comprises:
receiving a satellite sensor stereo data as input;
receiving user selection on desired quality level of output;
selecting optimum value of parameters required to generate output that matches said user selection on desired quality level of output; and
generating a plurality of output that match said user selection on desired quality level of output, wherein said plurality of outputs is at least one of an epi-polar image, digital elevation models (DEM), contour, slope, relief, and flythrough.

2. The method as claimed in claim 1, wherein said user selection on desired quality level of output is one of a Coarse, Moderate, or Fine.

3. The method as claimed in claim 1, wherein said user selection on desired quality level of output is defined at a project level.

4. The method as in claim 3, wherein all outputs generated as part of a single project have same quality level.

5. The method as claimed in claim 1, wherein selecting said optimum value of parameters further comprises of:
identifying a plurality of parameters required to generate each type of output; and
selecting said optimum value of each of said plurality of parameters, wherein said optimum value matches said user selection on desired quality level of output.

6. A system for automating data processing in a satellite photogrammetry system, said system configured for:
receiving a satellite sensor stereo data as input, using an Input/Output module;
receiving user selection on desired quality level of output, using said Input/Output module;
selecting optimum value of parameters required to generate output that matches said user selection on desired quality level of output, using an optimum value selection module; and
generating a plurality of outputs that match said user selection on desired quality level of output, using at least one of an Epi-polar creation module, autodem generation module, contour generation module, slope generation module, relief generation module, and a flythrough generation module, wherein said plurality of outputs is at least one of an epi-polar image, digital elevation models (DEM), contour, slope, relief, and flythrough.

7. The system as claimed in claim 6 is further configured to provide means for selecting said desired quality level of output as one of a Coarse, Moderate, or Fine.

8. The system as claimed in claim 6 is further configured to provide means for setting said desired quality level of output at a project level.

9. The system as claimed in claim 8 is further configured to generate all outputs associated with a single project, with same quality level.

10. The system as claimed in claim 1 is further configured to select said optimum value of parameters by:
identifying a plurality of parameters required to generate each type of output, using said optimum value selection module; and
selecting said optimum value of each of said plurality of parameters using said optimum value selection module, wherein said optimum value of each of said plurality of parameters matches said user selection on desired quality level of output.
